(19) United States
(12) Patent Application Publication
(10) Pub. No.: US 2026/0321269 A1
(43) Pub. Date: Oct. 15, 2026

(54) LOW COMPLEX BANDWIDTH EXTENSION TARGET GENERATION

(71) Applicant: Telefonaktiebolaget LM Ericsson (publ), Stockholm (SE)

(72) Inventor: Erik NORVELL, Upplands Väsby (SE)

(21) Appl. No.: 19/106,605

(22) PCT Filed: Sep. 6, 2023
(86) PCT No.: PCT/EP2023/074394

§ 371 Date: Feb. 25, 2025

Related U.S. Application Data
(60) Provisional application No. 63/405,000, filed on Sep. 9, 2022.

(51) Int. Cl. G10L 19/008; G10L 19/00; G10L 19/02

(52) U.S. Cl. CPC G10L 19/008; G10L 19/0018; G10L 19/0212

(57) ABSTRACT

An encoder, a computer program, a computer program product, and a method performed in an encoder. The method includes receiving a full band input frame. The method includes interpolating the full band input frame to an intermediate frame. The method includes performing a reversal of a spectrum of the intermediate frame to produce a spectrally reversed intermediate frame. The method includes interpolating the interpolated spectrally reversed intermediate frame to match a sampling frequency of a low pass filter and decimation process. The method includes performing a low pass filtering and decimation of the spectrally reversed spectrum to produce a band width extension, BWE, target signal.

### TECHNICAL FIELD

The present disclosure relates generally to communications, and more particularly to communication methods and related devices and nodes supporting wireless communications for speech and audio coding.

### BACKGROUND

Most existing telecommunication systems operate on a limited audio bandwidth. Stemming from the limitations of the land-line telephony systems, most voice services are limited to only transmitting the lower end of the frequency spectrum and only in a single mono channel. Although the lower bandwidth mono signal is enough for most conversations, there is a desire to increase bandwidth and spatial reproduction to improve intelligibility and sense of presence. The capacity in telecommunication networks is continuously increasing, but it is still of great interest to limit the required bandwidth per communication channel. In mobile networks smaller transmission bandwidths for each call yields lower power consumption in both the mobile device and the base station. This translates to energy and cost savings for the mobile operator, while the end user will experience prolonged battery life and increased talk-time. Further, with less consumed bandwidth per user the mobile network can service a larger number of users in parallel.

A property of the human auditory system is that the perception is frequency dependent. In particular, human hearing is less accurate for higher frequencies. This has inspired so called bandwidth extension (BWE) techniques, where a high frequency band is reconstructed from a low frequency band using only little additional information.

The conventional BWE uses a representation of the spectral envelope of the extended high band signal and reproduces the spectral fine structure of the signal by using a modified version of the low band signal. If the high band envelope is represented by a filter, the fine structure signal is often called the excitation signal. An accurate representation of the high band envelope is perceptually more important than the fine structure. Consequently, it is common that the available resources in terms of bits are spent on the envelope representation while the fine structure is reconstructed from the coded low band signal without additional side information. Further, the temporal shape of the high band may be adjusted using a temporal envelope. The basic concept of BWE is illustrated in FIG. 1, which is described in further detail below in the detailed description of various embodiments.

In a typical stereo recording the channel pair shows a high degree of similarity, or correlation. State-of-the-art stereo coding schemes exploit this correlation by employing parametric coding, where a single channel is encoded with high quality and complemented with a parametric description that enables reconstruction of the full stereo image. The process of reducing the channel pair into a single channel is often called a down-mix and the resulting channel the down-mix channel. The down-mix procedure typically tries to maintain the energy by aligning inter-channel time differences (ITD) and inter-channel phase differences (IPD) before mixing the channels. To maintain the energy balance of the input signal, the inter-channel level difference (ILD) is also measured. The ITD, IPD and ILD are then encoded and may be used in a reversed up-mix procedure when reconstructing the stereo channel pair at a decoder. The mentioned parameters describe the correlated components of the channel pair, while a stereo channel pair typically also includes a non-correlated component which cannot be reconstructed from the down-mix. This component may be represented with an inter-channel coherence parameter (ICC). The non-correlated component may be artificially synthesized at a stereo decoder by running the decoded down-mix channel through a decorrelator filter, which aims to create a signal which has low correlation with the decoded down-mix. The strength of the decorrelated component is then controlled with the ICC parameter. The same principles apply for multichannel audio such as 5.1 and 7.1.4, and spatial audio representations such as Ambisonics or Spatial Audio Object Coding. The number of channels is reduced by exploiting the correlation between the channels and bundling the reduced channel set with metadata or parameters for channel reconstruction or spatial audio rendering at the decoder.

To facilitate stereo or spatial audio signal reproduction at low bit rates, BWE techniques may be used in combination with parametric methods of spatial reconstruction. In this case, a down-mix is also produced for the BWE target band.

### SUMMARY

There currently exist certain challenge(s). The target generation from frequency domain is computationally complex. For a down-mix encoder operating on several modes, one solution is to inject zeros instead of synthesizing the target when operating in a mode where the BWE is not used, but this may lead to zeros in the target frame when switching back to a mode using the BWE. This will lead to energy loss and transition artefacts going to the mode using BWE.

Certain aspects of the disclosure and their embodiments may provide solutions to these or other challenges. According to some embodiments, a band limited BWE target signal is extracted from a full band target signal with a low complex operation consisting of linear interpolation, spectrum reversal, linear interpolation and low-pass filter and decimation.

According to some embodiments, a method in an encoder includes receiving a full band input frame. The method further includes interpolating the full band input frame to an intermediate frame. The method further includes performing a reversal of a spectrum of the intermediate frame to produce a spectrally reversed intermediate frame. The method further includes interpolating the spectrally reversed intermediate frame to match a sampling frequency of a low pass filter and decimation process. The method further includes performing a low pass filtering and decimation of the interpolated spectrally reversed intermediate frame to produce a band width extension, BWE, target signal.

Analogous encoders, computer programs, and computer program products are provided.

Certain embodiments may provide one or more of the following technical advantage(s). The various embodiments may provide a target BWE signal without additional delay and with low computational complexity.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a graphical illustration of the basic concept of bandwidth extension (BWE).

FIG. 2 is a block diagram illustrating a stereo encoder and decoder system;

FIG. 3 is a block diagram illustrating a down-mix encoder according to some embodiments;

FIG. 4 is a block diagram illustrating a down-mix decoder according to some embodiments;

FIG. 5 is a block diagram illustrating a BWE target extractor according to some embodiments;

FIG. 6 is a flow chart illustrating operations of an encoder according to some embodiments;

FIGS. 7A-7H are exemplary sample images and target bands according to some embodiments;

FIG. 8 is a graphical illustration of interpolation according to some embodiments;

FIG. 9 is a block diagram of an encoder according to some embodiments;

FIG. 10 is a block diagram of a decoder according to some embodiments;

FIG. 11 is a block diagram of a virtualization environment in accordance with some embodiments; and

FIGS. 12-13 are flow charts illustrating operations of an encoder according to some embodiments.

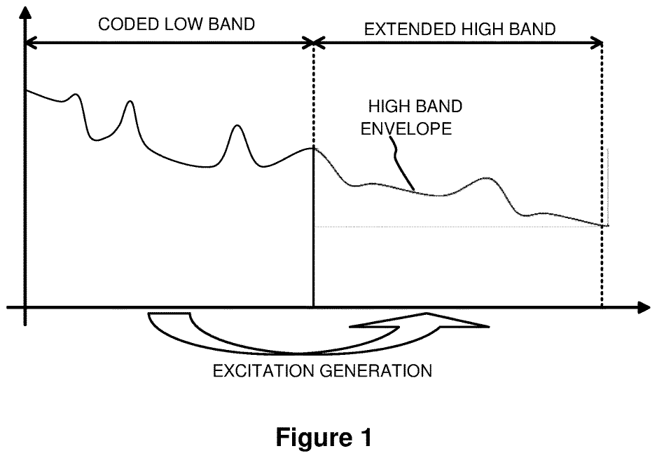

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, a target BWE signal without additional delay and with low computational complexity is provided.

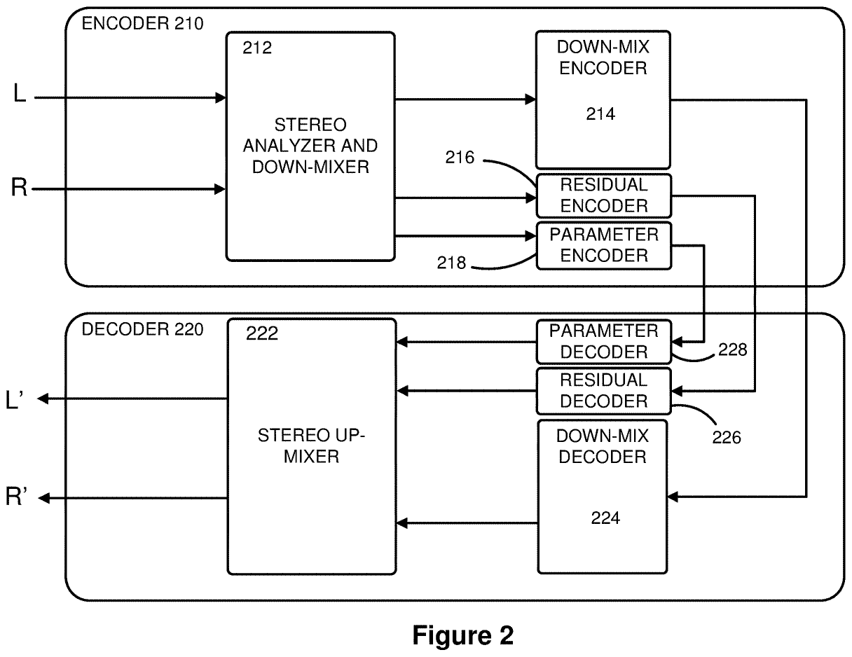

In one exemplary embodiment of the present disclosure, the embodiment operates in the stereo encoder of a stereo encoder and decoder system as outlined in FIG. 2. The stereo encoder 210 processes the input left and right channel signals in segments referred to as frames. The stereo analysis and down-mix block 212 conducts a parametric analysis and produces a down-mix. For a given frame m the input channels may be written as:

$$\{ \begin{matrix}l ( m , n ) \\ r ( m , n )\end{matrix}$$

where n=0,1,2, . . . , N denotes the sample number in frame m and N is the length of the frame m in the input sampling frequency fᵢₙₚᵤₜ. In the description that follows, an assumption is that the frames are extracted with an overlap in the encoder such that the decoder may reconstruct the stereo signals using an overlap add strategy. This means the analysis frame length N_{α} is typically larger than the input frame length N. The input signals on left and right channels are windowed with a suitable windowing function w(n) and transformed to DFT (discrete Fourier transform) domain.

$$\{ \begin{matrix}{X}_{L} ( m , k ) = {\sum }_{n = 0}^{{N}_{a} - 1} l ( m , n ) w ( n ) {e}^{- \frac{j 2 π kn}{{N}_{a}}} \\ {X}_{R} ( m , k ) = {\sum }_{n = 0}^{{N}_{a} - 1} r ( m , n ) w ( n ) {e}^{- \frac{j 2 π kn}{{N}_{a}}}\end{matrix}$$

Note that other frequency domain representation may be used here, such as a QMF (quadrature mirror filter) filter bank, a Hybrid QMF filter bank or an odd DFT (ODFT) representation which is composed of the MDCT (modified discrete cosine transform) and MDST (modified discrete sine transform) transform components.

For the parametric analysis, the frequency spectrum is partitioned into bands b, where each band corresponds to a range of frequency coefficients

$$k = {k}_{start ( b )} … {k}_{end ( b )} , b = 0 , 1 , 2 , … {N}_{bands} - 1$$

where N_{bands} denote the total number of bands. The band limits are typically set to reflect the resolution of the human auditory perception which suggests narrow bands for low frequencies and wider bands for high frequencies. Note that different band resolution may be used for different parameters.

The signals are then analyzed within the parametric analysis block to extract the ITD, IPD and ILD parameters. In addition, the channel coherence may be analyzed, and an ICC parameter may be derived. The parameters are encoded by a parameter encoder 218 and added to the bitstream to be stored or transmitted to a decoder. Optionally, a stereo residual bitstream may be produced by a residual encoder 216 and added to the bitstream to be stored or transmitted to a decoder.

Before producing a down-mix channel it may be beneficial to compensate for the ITD and IPD to reduce the cancellation and maximize the energy of the down-mix. The ITD compensation may be implemented both in time domain before the frequency transform or in frequency domain, but it essentially performs a time shift on one or both channels to eliminate the ITD. The phase alignment may be implemented in different ways, but the purpose is to align the phase such that the cancellation is minimized. This ensures maximum energy in the down-mix. The ITD and IPD adjustments may be done in frequency bands or on the full frequency spectrum and it should preferably be done using the quantized ITD and IPD parameters to ensure that the modification can be inverted in the decoder stage. The various embodiments described herein are independent of the realization of the IPD and ITD parameter analysis and compensation. Here, the ITD and IPD adjusted channels are denoted

$$\{ \begin{matrix}{X}_{L}^{′} ( m , k ) \\ {X}_{R}^{′} ( m , k )\end{matrix}$$

The down-mix signal X_{M}(m, k) is encoded by a down-mix encoder 214 to be stored or transmitted to a decoder. This encoding may be done in frequency domain, but it may also be done in time domain. In case of a time domain down-mix encoder, a DFT synthesis stage is required to produce at least one time domain version of the down-mix signal x_{M}(m, n), which is in turn fed to the down-mix encoder. If the down-mix encoder operates on several frequency bands of the down-mix signal, several DFT syntheses may be done to generate the time domain signals of the required bands.

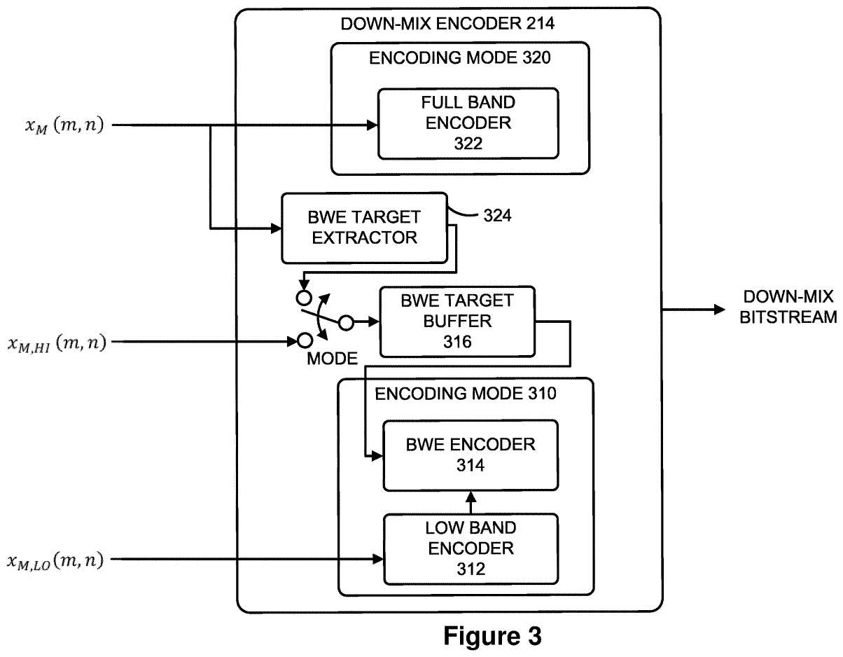

The down-mix encoder 214 is described in further detail in FIG. 3. The down-mix encoder 214 may contain at least two encoding modes, where at least one of the encoding modes 310 operates on at least two frequency bands using a low band encoder 312 and a BWE encoder 314. The encoding mode may for instance be selected using a signal analysis which selects the most appropriate mode, or it may be selected by running all possible modes and selecting the mode which gives the best performance for the current frame m. The low band encoder 312 receives a low band down-mix signal x_{M,LO}(m, n) and encodes a representation of this frequency band. The BWE encoder 314 receives a delay adjusted high band down-mix signal x′_{M, HI}(m, n) from a BWE target signal buffer 316. The buffer allows an alignment of the analysis frame which gives the desired analysis length and alignment, compensating any possible delay from the BWE process. Typically, the BWE encoder also uses parameters from the low-band encoder, such as the low-band excitation signal in a low band ACELP (algebraic code-excited linear prediction) encoder.

During the use of encoding mode 310, the BWE target buffer 316 is updated with the high band down-mix signal x_{M,HI}(m, n) which is generated by a DFT synthesis. In encoding mode 320, the full band down-mix signal x_{M}(m, n) is used as input to the full band encoder 322. The full band signal is also added to a low complex BWE target signal extractor 324. An alternative to extracting the BWE target signal is to run the DFT synthesis to produce the target signal the same way as when mode 310 is used. However, this solution may be computationally complex. Another solution could be to skip the target signal generation during use of mode 320 and inject zeros into the buffer 316. This would render almost zero additional complexity, but the buffer may partially contain zeros when the next frame is encoded using mode 310. This may lead to energy loss in the BWE region during transition to mode 310 which has a negative impact on the performance.

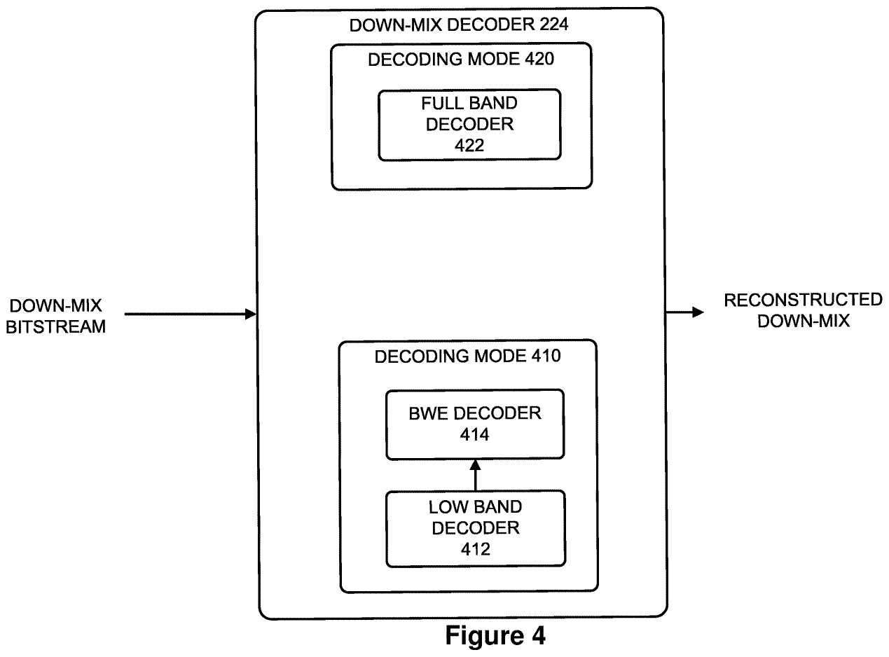

In the decoder 220, the stereo parameters are decoded by parameter decoder 228, and optionally a reconstructed residual signal is produced by a residual decoder 226. The down-mix decoder 224 is configured to decode and reconstruct the down-mix signal encoded by the down-mix encoder 214. As illustrated in FIG. 4, the down-mix decoder comprises at least a decoding mode 420 that has a full band decoder 422, and a decoding mode 410 having a low band decoder 412 and a BWE decoder 414. Similar to the encoder, the BWE decoder may use parameters from the low-band decoder, such as the low-band excitation signal of an ACELP decoder. The output of the decoding mode used for the current frame is a reconstructed down-mix. The reconstructed down-mix, the reconstructed stereo parameters and optionally a reconstructed residual signal is fed to a stereo up-mixer 222 to produce a reconstructed stereo signal.

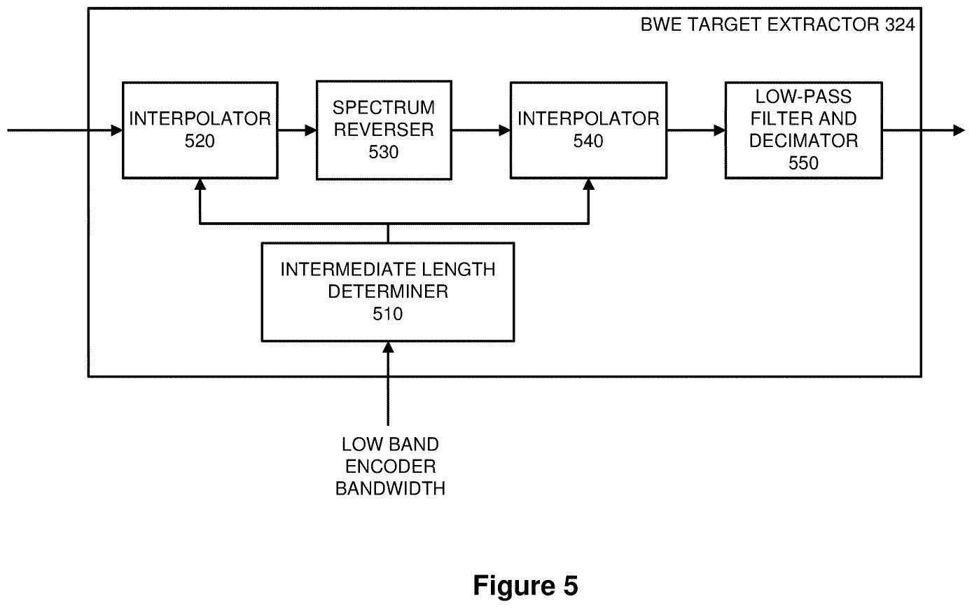

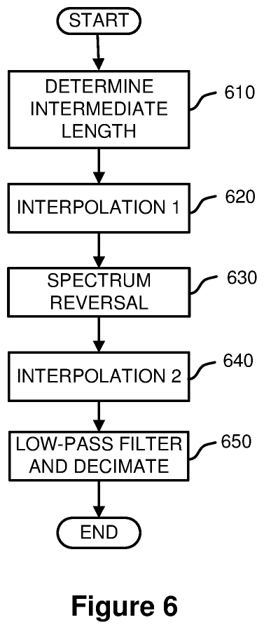

An efficient realization of the BWE target extractor 324 can be seen in FIG. 5, following the steps outlined in FIG. 6. In case the BWE operates on several different target bands, and optional initial step 610 may be done by intermediate length determiner 510 to determine an intermediate length of the interpolated signal. The intermediate length is determined by rescaling the length of the input frame N in the input sampling frequency fᵢₙₚᵤₜ such that the upper limit of the target band matches the Nyquist frequency in the interpolated frame. If the target band has the limits (fₗₒ, fₕᵢ), the intermediate sampling frequency fᵢₙₜₑᵣ is

$${f}_{inter} = 2 {f}_{hi}$$

and the intermediate length Nᵢₙₜₑᵣ is

$${N}_{inter} = N \frac{{f}_{inter}}{{f}_{input}}$$

Different target bands may depend on the bandwidth of the low band encoder. If the low band encoder uses a lower bandwidth, the start of the BWE target band should match the end of the low band bandwidth. Typically, the BWE target band is extracted to have a small overlap with the low band encoder bandwidth to ensure a smooth frequency transition between the encoded bands.

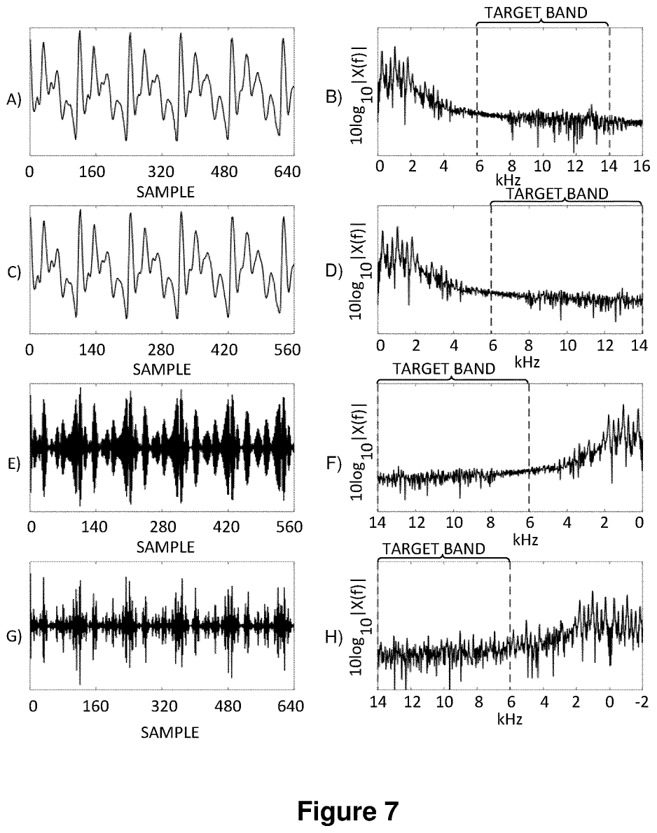

In step 620, the interpolator 520 performs an interpolation of the full band input frame x_{M}(m, n) to an intermediate frame xᵢₙₜₑᵣ(m, n). An example input frame of length N=640 and sampling frequency of fᵢₙₚᵤₜ=32 kHz is illustrated in FIG. 7A with a frequency spectrum and target band illustrated in FIG. 7B.

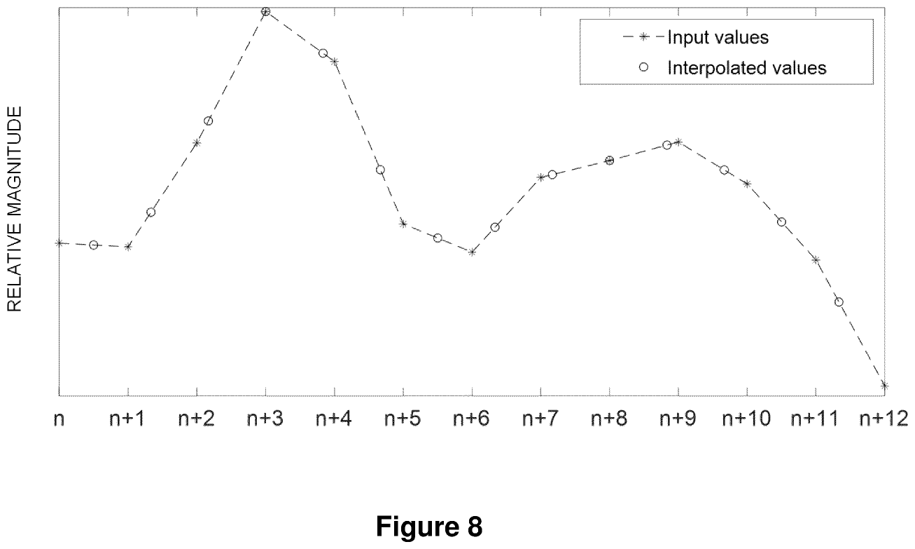

The interpolator may use linear interpolation, as illustrated in FIG. 8. The sample points are assumed to be connected by straight lines, and the resampling uses the sampling point intersecting with the line. Generally, a linear interpolation function that stretches or compresses a frame of length N₁ to a frame of length N₂ may be written as

$${x}_{int} ( i ) = \{ \begin{matrix}x ( 0 ) + {i}_{frac} ( x ( 1 ) - x ( 0 ) ) , & {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , & {i}_{frac} > {N}_{1} - 1 \\ x ( {i}_{floor} ) + ( {i}_{frac} - {i}_{floor} ) ( x ( {i}_{floor} + 1 ) - x ( {i}_{floor} ) ) , & otherwise\end{matrix}$$

$$for i = 0 , 1 , … , {N}_{2} , where$$

$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$

The first two lines of the equality for xᵢₙₜ(i) is handling the cases on the edges of the frame where the new sampling point is extrapolated from the two last points of the frame or two first points of the frame. The index offset i_{offset} handles the case when N₂>N₁ and the first sample point in the stretched frame would be below i=0 and the last sample point exceeding i=N₁−1. In some cases, a displacement is desirable, here denoted E. In one embodiment, ∈ may be defined according to

$$ϵ = \{ \begin{matrix}- 0.13 , & {N}_{1} / {N}_{2} > 0.3 \\ 0 , & otherwise\end{matrix}$$

The linear interpolation offers a cheap resampling at the cost of high aliasing. There is some weak low-pass filtering built in due to the linear interpolation. However, the aliasing is limited if the resampling is not too large. Further, the BWE target signal is not directly encoded but only used for spectral shaping, temporal shaping and energy measurement. For this reason, it is less sensitive to aliasing. It should be noted that other variants of low complex interpolation may also be used.

The result of the interpolation step 620 is illustrated in FIG. 7C where Nᵢₙₜₑᵣ=560 and the upper limit of the target band now matches the Nyquist frequency in FIG. 7D. In step 630, the spectrum reverser 530 performs a reversal of the spectrum of the intermediate frame. This may be implemented by changing the sign of every second sample.

$${x}_{inter , rev} ( m , n ) = \{ \begin{matrix}- {x}_{inter , rev} ( m , n ) , & n is even \\ {x}_{inter , rev} ( m , n ) , & n is odd\end{matrix} , n = 0 , 1 , … , {N}_{inter} - 1$$

Alternatively, a spectrum reversal equivalent for this purpose can be obtained with

$${x}_{inter , rev} ( m , n ) = \{ \begin{matrix}- {x}_{inter , rev} ( m , n ) , & n is odd \\ {x}_{inter , rev} ( m , n ) , & n is even\end{matrix} , n = 0 , 1 , … , {N}_{inter} - 1$$

The result of the spectrum reversal is illustrated in FIG. 7E with its reversed spectrum in FIG. 7F. In step 640, the interpolator 540 adjusts the frame length to match the sampling frequency of step 650, where a low-pass filter and decimator 550 performs a low-pass filter and decimation to produce the BWE target signal. Here, the decimator performs a decimation by 2, which gives an output sampling frequency of half the input sampling frequency. The low-pass filter has a cut-off frequency in the middle of the spectrum. In the example illustrated in FIG. 7, the low-pass filter and decimator operates on f_{dec}=32 kHz, which gives a decimator frame length of

$${N}_{dec} = {N}_{inter} \frac{{f}_{dec}}{{f}_{inter}}$$

which in the illustrated example evaluates to N_{dec}=640. After performing this interpolation, the decimator frame x_{dec}(m, n) is illustrated in FIG. 7G. In the frequency spectrum illustrated in FIG. 7H, the target band is now aligned in the lower half of the spectrum. This is the frequency band that the low-pass filter and decimator 550 then extracts to give the extracted BWE target signal. Note that the spectrum of the BWE target signal is now reversed. If the BWE encoder operates on reversed frequency spectrum, the target signal is ready to be fed to the BWE target buffer 316. If the spectrum needs to be reversed, a spectrum reversal may be done as described earlier by changing the sign of every second sample.

The down-mix encoder outputs the encoded representation from the down-mix encoding mode into a down-mix bitstream. This bitstream is then joined with the bitstream of the parameter encoder 218. Optionally, a stereo residual bitstream may be produced by a residual encoder 216. The bitstream components of the active modules is joined into a compound bitstream to be stored or transmitted to a decoder.

As described earlier, in the decoder 220, the stereo parameters are decoded by the parameter decoder 228, and optionally a reconstructed residual signal is produced by the residual decoder 226. The down-mix decoder 224 is configured to decode and reconstruct the down-mix signal encoded by the down-mix encoder 214. The output of the active decoding mode is a reconstructed down-mix. The reconstructed down-mix, the reconstructed stereo parameters and optionally a reconstructed residual signal is fed to a stereo up-mixer 222 to produce the reconstructed stereo signal.

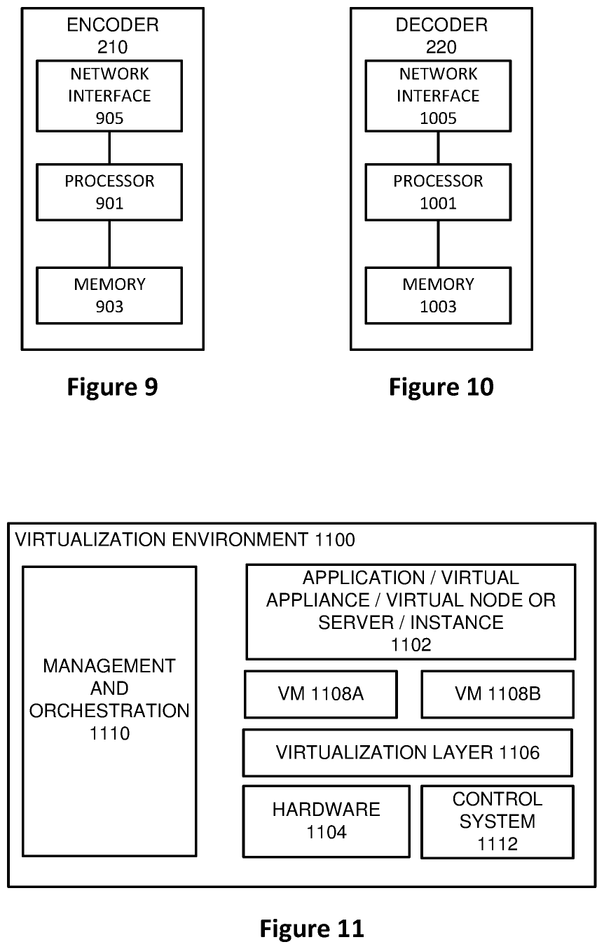

Prior to describing operations from the perspective of the encoder 210, FIG. 9 is a block diagram illustrating elements of the encoder 210 configured to encode audio frames according to the various embodiments herein. As shown, encoder 210 may include a network interface circuitry 905 (also referred to as a network interface) configured to provide communications with other devices/entities/functions/etc. The encoder 210 may also include processing circuitry 901 (also referred to as a processor and processor circuitry) coupled to the network interface circuitry 905, and a memory circuitry 903 (also referred to as memory) coupled to the processing circuit. The memory circuitry 903 may include computer readable program code that when executed by the processing circuitry 901 causes the processing circuit to perform operations according to embodiments disclosed herein.

According to other embodiments, processing circuitry 901 may be defined to include memory so that a separate memory circuit is not required. As discussed herein, operations of the encoder 210 may be performed by processing circuitry 901 and/or network interface 905. For example, processing circuitry 901 may control network interface 905 to transmit communications to decoder 220 and/or to receive communications through network interface 905 from one or more other network nodes/entities/servers such as other encoder nodes, depository servers, etc. Moreover, modules may be stored in memory 903, and these modules may provide instructions so that when instructions of a module are executed by processing circuitry 901, processing circuitry 901 performs respective operations.

FIG. 10 is a block diagram illustrating elements of decoder 220 configured to decode audio frames according to some embodiments of inventive concepts. As shown, decoder 220 may include a network interface circuitry 1005 (also referred to as a network interface) configured to provide communications with other devices/entities/functions/etc. The decoder 220 may also include a processing circuitry 1001 (also referred to as a processor or processor circuitry) coupled to the network interface circuit 1005, and a memory circuitry 1003 (also referred to as memory) coupled to the processing circuit. The memory circuitry 1003 may include computer readable program code that when executed by the processing circuitry 1001 causes the processing circuit to perform operations according to embodiments disclosed herein.

According to other embodiments, processing circuitry 1001 may be defined to include memory so that a separate memory circuit is not required. As discussed herein, operations of the decoder 220 may be performed by processor 1001 and/or network interface 1005. For example, processing circuitry 1001 may control network interface circuitry 1005 to receive communications from encoder 210. Moreover, modules may be stored in memory 1003, and these modules may provide instructions so that when instructions of a module are executed by processing circuitry 1001, processing circuitry 1001 performs respective operations.

In some embodiments, various operations of the encoder 210 and/or decoder 220 may be distributed across various components. FIG. 11 is a block diagram illustrating a virtualization environment 1100 in which functions implemented by some embodiments may be virtualized. In the present context, virtualizing means creating virtual versions of apparatuses or devices such as encoders and/or decoders which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as an encoder, a decoder, a network node, UE, core network node, etc.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108A and 1108B (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

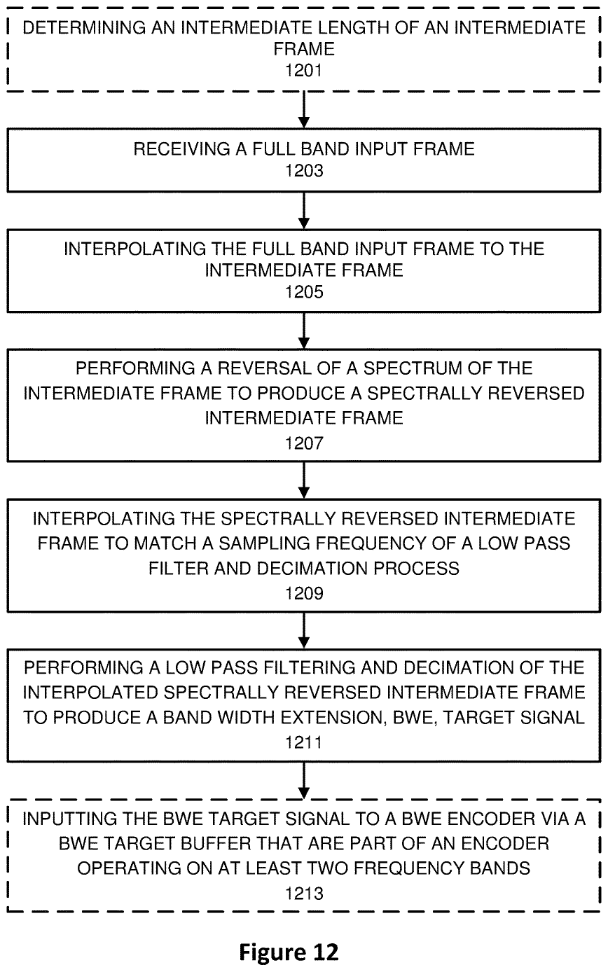

Operations of the encoder 210 (implemented using the structure of the block diagram of FIG. 9) will now be discussed with reference to the flow chart of FIG. 12 according to some embodiments of inventive concepts. For example, modules may be stored in memory 903 of FIG. 9, and these modules may provide instructions so that when the instructions of a module are executed by respective encoder processing circuitry 901, the encoder 210 performs respective operations of the flow chart.

Turning to FIG. 12, in block 1201, the encoder 210 determines an intermediate length of an intermediate frame. In some embodiments, the encoder 210 determines the intermediate length by rescaling a length of an input frame N in the input sampling frequency fᵢₙₚᵤₜ until an upper limit of a target band matches a Nyquist frequency in the intermediate frame.

In some of these embodiments, the encoder 210 determines the intermediate length in accordance with

$${N}_{inter} = N \frac{{f}_{inter}}{{f}_{input}}$$

where

$${f}_{inter} = 2 {f}_{hi}$$

when a target band has limits (fₗₒ, fₕᵢ), Nᵢₙₜₑᵣ is the intermediate length, N is a length of an input frame, and fᵢₙₜₑᵣ is the intermediate sampling frequency.

In block 1203, the encoder 210 receives a full band input frame. For example, in some embodiments, the encoder 210 receives the full band input frame by receiving a full band down-mix signal generated by a discrete Fourier transform, DFT, synthesis as described above.

In block 1205, the encoder 210 interpolates the full band input frame to an intermediate frame. In some embodiments, the encoder 210 interpolates the full band input frame by interpolating the full band input frame using a linear interpolation.

In some embodiments of using a linear interpolation, the encoder 210 uses the linear interpolation to stretch or compress a frame of length N₁ to a frame of length N₂ in accordance with

$${x}_{int} ( i ) = \{ \begin{matrix}x ( 0 ) + {i}_{frac} ( x ( 1 ) - x ( 0 ) ) , & {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , & {i}_{frac} > {N}_{1} - 1 \\ x ( {i}_{floor} ) + ( {i}_{frac} - {i}_{floor} ) ( x ( {i}_{floor} + 1 ) - x ( {i}_{floor} ) ) , & otherwise\end{matrix}$$

$$for i = 0 , 1 , … , {N}_{2} , where$$

$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$

wherein xᵢₙₜ(i) is an interpolated sampling value at point i, x(0) is a sampling point in the source vector x at a first point 0, x(1) is a sampling point in the source vector x at a second point 1, i_{frac} is a fractional point where the source vector x is to be estimated, i_{offset} is an offset, and E is a displacement. As previously described, the offset i_{offset} handles the case when N₂>N₁ and the first sample point in the stretched frame would be below i=0 and the last sample point exceeding i=N₁−1.

In some of these embodiments, e is defined in accordance with

$$ϵ = \{ \begin{matrix}- 0.13 , & {N}_{1} / {N}_{2} > 0.3 \\ 0 , & otherwise\end{matrix}$$

Other displacements may be used.

In block 1207, the encoder 210 performs a reversal of the spectrum of the intermediate frame to produce a spectrally reversed intermediate frame. In some embodiments, the encoder 210 performs the reversal of the spectrum in accordance with:

$${x}_{inter , rev} ( m , n ) = \{ \begin{matrix}- {x}_{inter , rev} ( m , n ) , & n is even \\ {x}_{inter , rev} ( m , n ) , & n is odd\end{matrix} , n = 0 , 1 , … , {N}_{inter} - 1$$

In some other embodiments, the encoder 210 performs the reversal of the spectrum

$${x}_{inter , rev} ( m , n ) = \{ \begin{matrix}- {x}_{inter , rev} ( m , n ) , & n is odd \\ {x}_{inter , rev} ( m , n ) , & n is even\end{matrix} , n = 0 , 1 , … , {N}_{inter} - 1$$

In block 1209, the encoder 210 interpolates the spectrally reversed intermediate frame to match a sampling frequency of a low pass filter and decimation process. In block 1211, the encoder 210 performs a low pass filtering and decimation of the interpolated spectrally reversed intermediate frame to produce a band width extension, BWE, target signal.

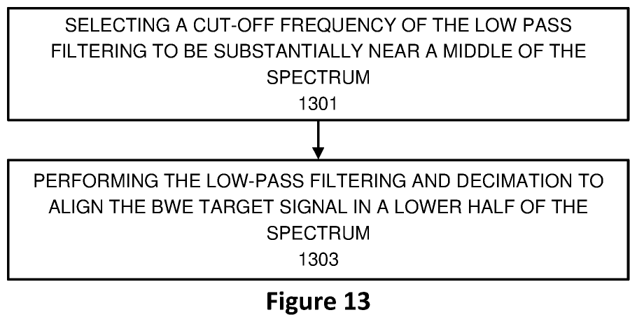

In some embodiments as illustrated in FIG. 13, the encoder 210 selects a cut-off frequency of the low pass filtering to be substantially near a middle of the spectrum as illustrated in block 1301. In block 1303, the encoder 210 performs the low pass filtering and decimation of the reversed spectrum to produce the BWE target signal by performing the low pass filtering and decimation to align the BWE target signal in a lower half of the spectrum.

In some of these embodiments, the encoder 210 determines the decimator frame length in accordance with

$${N}_{dec} = {N}_{inter} \frac{{f}_{dec}}{{f}_{inter}}$$

where N_{dec} is the decimator frame length, Nᵢₙₜₑᵣ is an intermediate length, f_{dec} is a frequency of operation of a decimator, and fᵢₙₜₑᵣ is a frequency of the intermediate frame.

Returning to FIG. 12, in block 1213, the encoder 210 inputs the BWE target signal to a BWE encoder 314 via a BWE target buffer 316, where the BWE encoder 314 and the BWE target buffer 316 are part of encoder 210 operating on at least two frequency bands. In an embodiment, the BWE encoder 314 and BWE target buffer 316 are part of a down-mix encoder 214. The down-mix encoder 214 of the encoder 210 in some embodiments has at least two encoding modes, wherein at least one of the at least two encoding modes has a BWE encoder 314.

In some of these embodiments, the encoder 210 operates on a down-mix signal in a parametric stereo encoder.

Various operations from the flow chart of FIG. 12 may be optional with respect to some embodiments of communication devices and related methods. Regarding methods of example embodiment 1 (set forth below), for example the operations of blocks 1201 and 1213 of FIG. 12 may be optional.

Although the computing devices described herein (e.g., encoders, decoders, UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### EMBODIMENTS

Embodiment 1. A method performed in an encoder (210, 1108A, 1108B), the method comprising:
   receiving (1203) a full band input frame;
   interpolating (620, 1205) the full band input frame to an intermediate frame;
   performing (630, 1207) a reversal of a spectrum of the intermediate frame to produce a spectrally reversed intermediate frame;
   interpolating (640,1209) the spectrally reversed intermediate frame to match a sampling frequency of a low pass filter and decimation process; and
   performing (650, 1211) a low pass filtering and decimation of the interpolated spectrally reversed intermediate frame to produce a band width extension, BWE, target signal.
Embodiment 2. The method of Embodiment 1, wherein interpolating the full band input frame comprises using a linear interpolation in interpolating the full band input frame.
Embodiment 3. The method of Embodiment 2, wherein using the linear interpolation in interpolating the full band input comprises using the linear interpolation to stretch or compress a frame of length N₁ to a frame of length N₂ in accordance with

$${x}_{int} ( i ) = \{ \begin{matrix}x ( 0 ) + {i}_{frac} ( x ( 1 ) - x ( 0 ) ) , & {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , & {i}_{frac} > {N}_{1} - 1 \\ x ( {i}_{floor} ) + ( {i}_{frac} - {i}_{floor} ) ( x ( {i}_{floor} + 1 ) - x ( {i}_{floor} ) ) , & otherwise\end{matrix}$$

$$for i = 0 , 1 , … , {N}_{2} , where$$

$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$

wherein xᵢₙₜ(i) is an interpolated sampling value at point i, x(0) is a sampling point in the source vector x at a first point 0, x(1) is a sampling point in the source vector x at a second point 1, i_{offset} is an offset, and e is a displacement.
Embodiment 4. The method of Embodiment 3 wherein e is defined in accordance with

$$ϵ = \{ \begin{matrix}- 0.13 , & {N}_{1} / {N}_{2} > 0.3 \\ 0 , & otherwise\end{matrix}$$

Embodiment 5. The method of any of Embodiments 1~4 wherein receiving the full band input frame comprises receiving a full band down-mix signal generated by a discrete Fourier transform, DFT, synthesis.
Embodiment 6. The method of any of Embodiments 1-5, wherein performing the reversal of the spectrum of the intermediate frame comprises performing the reversal of the spectrum in accordance with:

$${x}_{inter , rev} ( m , n ) = \{ \begin{matrix}- {x}_{inter , rev} ( m , n ) , & n is even \\ {x}_{inter , rev} ( m , n ) , & n is odd\end{matrix} , n = 0 , 1 , … , {N}_{inter} - 1$$

Embodiment 7. The method of any of Embodiments 1-5, wherein performing the reversal of the spectrum of the intermediate frame comprises performing the reversal of the spectrum in accordance with:

$${x}_{inter , rev} ( m , n ) = \{ \begin{matrix}- {x}_{inter , rev} ( m , n ) , & n is odd \\ {x}_{inter , rev} ( m , n ) , & n is even\end{matrix} , n = 0 , 1 , … , {N}_{inter} - 1$$

Embodiment 8. The method of any of Embodiments 1-7, further comprising:
   determining (610, 1201) an intermediate length of the intermediate frame.
Embodiment 9. The method of Embodiment 8 wherein determining the intermediate length comprises rescaling a length of an input frame N in the input sampling frequency fᵢₙₚᵤₜ until an upper limit of a target band matches a Nyquist frequency in the intermediate frame.
Embodiment 10. The method of any of Embodiments 8-9, wherein determining the intermediate length comprises determining the intermediate length in accordance with

$${N}_{inter} = N \frac{{f}_{inter}}{{f}_{input}}$$

where

$${f}_{inter} = 2 {f}_{hi}$$

when a target band has limits (fₗₒ, fₕᵢ), Nᵢₙₜₑᵣ is the intermediate length, N is a length of an input frame, and fᵢₙₚᵤₜ is the intermediate sampling frequency.
Embodiment 11. The method of any of Embodiments 1-10, further comprising selecting (1301) a cut-off frequency of the low pass filtering to be substantially near a middle of the spectrum.
Embodiment 12. The method of Embodiment 11, wherein performing the low pass filtering and decimation of the reversed spectrum to produce the BWE target signal comprises performing (1303) the low pass filtering and decimation to align the BWE target signal in a lower half of the spectrum.
Embodiment 13. The method of Embodiment 12 wherein a decimator frame length is determined in accordance with

$${N}_{dec} = {N}_{inter} \frac{{f}_{dec}}{{f}_{inter}}$$

where N_{dec} is the decimator frame length, Nᵢₙₜₑᵣ is an intermediate length, f_{dec} is a frequency of operation of a decimator, and fᵢₙₜₑᵣ is a frequency of the intermediate frame.
Embodiment 14. The method of any of Embodiments 1-13, further comprising inputting (1213) the BWE target signal to a BWE encoder (314) via a BWE target buffer (316), where the BWE encoder (314) and BWE target buffer (316) are part of an encoder (210, 1108A, 1108B) operating on at least two frequency bands.
Embodiment 15. The method of Embodiment 14 wherein the BWE encoder (314) and the BWE target buffer (316) are part of a down-mix encoder (214) of the encoder (210, 1108A, 1108B)
Embodiment 16. The method of Embodiment 15, wherein the down-mix encoder (214) of the encoder (210, 1108A, 1108B) comprises at least two encoding modes, wherein at least one of the at least two encoding modes has the BWE encoder (314).
Embodiment 17. The method of Embodiment 16, wherein the encoder (210, 1108A, 1108B) operates on a down-mix signal in a parametric stereo encoder.
Embodiment 18. An encoder (210, 1108A, 1108B) adapted to:
   receive (1203) a full band input frame;
   interpolate (620, 1205) the full band input frame to an intermediate frame;
   perform (630, 1207) a reversal of a spectrum of the intermediate frame to produce a spectrally reversed intermediate frame;
   interpolate (640, 1209) the spectrally reversed intermediate frame to match a sampling frequency of a low pass filter and decimation process; and
   perform (650, 1211) a low pass filtering and decimation of the interpolated spectrally reversed intermediate frame to produce a band width extension, BWE, target signal.
Embodiment 19. The encoder (210, 1108A, 1108B) of Embodiment 18, wherein interpolating the full band input frame comprises using a linear interpolation in interpolating the full band input frame.
Embodiment 20. The encoder (210, 1108A, 1108B) of Embodiment 19, wherein using the linear interpolation in interpolating the full band input comprises using the linear interpolation to stretch or compress a frame of length N₁ to a frame of length N₂ in accordance with

$${x}_{int} ( i ) = \{ \begin{matrix}x ( 0 ) + {i}_{frac} ( x ( 1 ) - x ( 0 ) ) , & {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , & {i}_{frac} > {N}_{1} - 1 \\ x ( {i}_{floor} ) + ( {i}_{frac} - {i}_{floor} ) ( x ( {i}_{floor} + 1 ) - x ( {i}_{floor} ) ) , & otherwise\end{matrix}$$

$$for i = 0 , 1 , … , {N}_{2} , where$$

$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$

wherein xᵢₙₜ(i) is an interpolated sampling value at point i, x(0) is a sampling point in the source vector x at a first point 0, x(1) is a sampling point in the source vector x at a second point 1, i_{offset} is an offset, and e is a displacement.
Embodiment 21. The encoder (210, 1108A, 1108B) of Embodiment 20 wherein e is defined in accordance with

$$ϵ = \{ \begin{matrix}- 0.13 , & {N}_{1} / {N}_{2} > 0.3 \\ 0 , & otherwise\end{matrix}$$

Embodiment 22. The encoder (210, 1108A, 1108B) of any of Embodiments 18-21 wherein receiving the full band input frame comprises receiving a full band down-mix signal generated by a discrete Fourier transform, DFT, synthesis.
Embodiment 23. The encoder (210, 1108A, 1108B) of any of Embodiments 18-22, wherein performing the reversal of the spectrum of the intermediate frame comprises performing the reversal of the spectrum in accordance with:

$${x}_{inter , rev} ( m , n ) = \{ \begin{matrix}- {x}_{inter , rev} ( m , n ) , & n is even \\ {x}_{inter , rev} ( m , n ) , & n is odd\end{matrix} , n = 0 , 1 , … , {N}_{inter} - 1$$

Embodiment 24. The encoder (210, 1108A, 1108B) of any of Embodiments 18-22, wherein performing the reversal of the spectrum of the intermediate frame comprises performing the reversal of the spectrum in accordance with:

$${x}_{inter , rev} ( m , n ) = \{ \begin{matrix}- {x}_{inter , rev} ( m , n ) , n is odd \\ {x}_{inter , rev} ( m , n ) , n is even\end{matrix} , n = 0 , 1 , … , {N}_{inter} = 1$$

Embodiment 25. The encoder (210, 1108A, 1108B) of any of Embodiments 18-24, wherein the encoder (210, 1108A, 1108B) is further adapted to:
   determine (610, 2201) an intermediate length of the intermediate frame.
Embodiment 26. The encoder (210, 1108A, 1108B) of Embodiment 25 wherein determining the intermediate length comprises rescaling a length of an input frame N in the input sampling frequency fᵢₙₚᵤₜ until an upper limit of a target band matches a Nyquist frequency in the intermediate frame.
Embodiment 27. The encoder (210, 1108A, 1108B) of any of Embodiments 25-26, wherein determining the intermediate length comprises determining the intermediate length in accordance with

$${N}_{inter} = N \frac{{f}_{inter}}{{f}_{input}}$$

where

$${f}_{inter} = 2 {f}_{hi}$$

when a target band has limits (fₗₒ, fₕᵢ), Nᵢₙₜₑᵣ is the intermediate length, N is a length of an input frame, and fᵢₙₚᵤₜ is the intermediate sampling frequency.
Embodiment 28. The encoder (210, 1108A, 1108B) of any of Embodiments 18-27, wherein the encoder (210, 1108A, 1108B) is further adapted to select (1301) a cut-off frequency of the low pass filtering to be substantially near a middle of the spectrum.
Embodiment 29. The encoder (210, 1108A, 1108B) of Embodiment 28, wherein performing the low pass filtering and decimation of the reversed spectrum to produce the BWE target signal comprises performing (1303) the low pass filtering and decimation to align the BWE target signal in a lower half of the spectrum.
Embodiment 30. The encoder (210, 1108A, 1108B) of Embodiment 29 wherein a decimator frame length is determined in accordance with

$${N}_{dec} = {N}_{inter} \frac{{f}_{dec}}{{f}_{inter}}$$

where N_{dec} is the decimator frame length, Nᵢₙₜₑᵣ is an intermediate length, f_{dec} is a frequency of operation of a decimator, and fᵢₙₜₑᵣ is a frequency of the intermediate frame.
Embodiment 31. The encoder (210, 1108A, 1108B) of any of Embodiments 18-30, wherein the encoder (210, 1108A, 1108B) is further adapted to input (1213) the BWE target signal to a BWE encoder (314) via a BWE target buffer (316), where the BWE encoder (314) and the BWE target buffer (316) are part of the encoder (210, 1108A, 1108B) operating on at least two frequency bands.
Embodiment 32. The encoder (210, 1108A, 1108B) of Embodiment 31 wherein the BWE encoder (314) and BWE target buffer (316) are part of a down-mix encoder (214) of the encoder (210, 1108A, 1108B).
Embodiment 33. The encoder (210, 1108A, 1108B) of Embodiment 30, wherein the down-mix encoder (214) of the encoder (210, 1108A, 1108B) comprises at least two encoding modes, wherein at least one of the at least two encoding modes has the BWE encoder (314).
Embodiment 34. The encoder (210, 1108A, 1108B) of Embodiment 33, wherein the encoder (210, 1108A, 1108B) operates on a down-mix signal in a parametric stereo encoder.
Embodiment 35. An encoder (210, 1108A, 1108B) comprising:
   processing circuitry (901);
   memory (903) coupled with the processing circuitry, wherein the memory includes instructions that when executed by the processing circuitry causes the encoder (210, 1108A, 1108B) to perform operations comprising:
      receiving (1203) a full band input frame;
      interpolating (1205) the full band input frame to an intermediate frame;
      performing (1207) a reversal of a spectrum of the intermediate frame to produce a spectrally reversed intermediate frame;
      interpolating (1209) the frequency reversed intermediate frame to match a sampling frequency of a low pass filter and decimation process; and
      performing (1211) a low pass filtering and decimation of the interpolated spectrally reversed intermediate frame to produce a band width extension, BWE, target signal.
Embodiment 36. The encoder (100, 1008A, 1008B) of Embodiment 35, wherein the memory comprises further instructions that when executed by the processing circuitry causes the encoder (210, 1108A, 1108B) to perform operations according to any of Embodiments 2-17.
Embodiment 37. A computer program comprising program code to be executed by processing circuitry (903) of an encoder (210, 1108A, 1108B), whereby execution of the program code causes the encoder (210,1008A, 1008B) to perform operations comprising:
   receiving (1203) a full band input frame;
   interpolating (1205) the full band input frame to an intermediate frame;
   performing (1207) a reversal of a spectrum of the intermediate frame to produce a spectrally reversed intermediate frame;
   interpolating (1209) the spectrally reversed intermediate frame to match a sampling frequency of a low pass filter and decimation process; and
   performing (1211) a low pass filtering and decimation of the interpolated spectrally reversed intermediate frame to produce a band width extension, BWE, target signal.
Embodiment 38. The computer program of Embodiment 37, wherein the computer program comprises further program code that when executed by the processing circuitry (903) of the encoder (210,1008A, 1008B) causes the encoder (210,1008A, 1008B) to perform further operations according to any of Embodiments 2-17.
Embodiment 39. A computer program product comprising a non-transitory computer readable storage medium having program code, to be executed by processing circuitry (903) of an encoder (210,1008A, 1008B), whereby execution of the program code causes the encoder (210, 1108A, 1108B) to perform operations comprising:
   receiving (1203) a full band input frame;
   interpolating (1205) the full band input frame to an intermediate frame;
   performing (1207) a reversal of a spectrum of the intermediate frame to produce a spectrally reversed intermediate frame;
   interpolating (1209) the spectrally reversed intermediate frame to match a sampling frequency of a low pass filter and decimation process; and
   performing (1211) a low pass filtering and decimation of the interpolated spectrally reversed intermediate frame to produce a band width extension, BWE, target signal.
Embodiment 40. The computer program product of Embodiment 39, wherein the non-transitory computer readable storage medium comprises further program code that when executed by the processing circuitry (903) of the encoder (210,1008A, 1008B) causes the encoder (210,1008A, 1008B) to perform further operations according to any of Embodiments 2-17.

1. A method performed in an encoder, the method comprising:
receiving a full band input frame;
interpolating the full band input frame to an intermediate frame;
performing a reversal of a spectrum of the intermediate frame to produce a spectrally reversed intermediate frame;
interpolating the spectrally reversed intermediate frame to match a sampling frequency of a low pass filter and decimation process; and
performing a low pass filtering and decimation of the interpolated spectrally reversed intermediate frame to produce a band width extension, BWE, target signal.

2. The method of claim 1, further comprising:
determining an intermediate length of the intermediate frame Nᵢₙₜₑᵣ.

3. The method of claim 2 wherein determining the intermediate length comprises rescaling a length of an input frame N in an input sampling frequency fᵢₙₚᵤₜ until an upper limit of a target band matches a Nyquist frequency in the intermediate frame.

4. The method of claim 2, wherein determining the intermediate length comprises determining the intermediate length in accordance with
$${N}_{inter} = N \frac{{f}_{inter}}{{f}_{input}}$$
where
$${f}_{inter} = 2 {f}_{hi}$$
when a target band has limits (fₗₒ, fₕᵢ), Nᵢₙₜₑᵣ is the intermediate length, N is a length of an input frame, and fᵢₙₚᵤₜ is the intermediate sampling frequency.

5. The method of claim 1, wherein interpolating the full band input frame comprises using a linear interpolation in interpolating the full band input frame, and wherein using the linear interpolation in interpolating the full band input frame comprises using the linear interpolation to stretch or compress a frame of length N₁ to a frame of length N₂ in accordance with
$${x}_{int} ( i ) = \{ \begin{matrix}\begin{matrix}x ( 0 ) + {i}_{frac} ( x ( 1 ) - x ( 0 ) ) , {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , {i}_{frac} > {N}_{1} - 1\end{matrix} \\ x ( {i}_{foor} ) + ( {i}_{frac} - {i}_{floor} ) ( x ( {i}_{floor} + 1 ) - x ( {i}_{floor} ) ) , otherwise\end{matrix}$$
$$for i = 0 , 1 , … , {N}_{2} , where$$
$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$
wherein xᵢₙₜ(i) is an interpolated sampling value at point i, x(0) is a sampling point in the source vector x at a first point 0, x(1) is a sampling point in the source vector x at a second point 1, i_{frac} is a fractional point where the source vector x is to be estimated, i_{offset} is an offset, and e is a displacement.

6. (canceled)

7. (canceled)

8. The method of claim 1 wherein receiving the full band input frame comprises receiving a full band down-mix signal generated by a discrete Fourier transform, DFT, synthesis.

9. The method of claim 1, wherein performing the reversal of the spectrum of the intermediate frame comprises performing the reversal of the spectrum in accordance with:
$${x}_{inter , rev} ( m , n ) = \{ \begin{matrix}- {x}_{inter , rev} ( m , n ) , n is even \\ {x}_{inter , rev} ( m , n ) , n is odd\end{matrix} , n = 0 , 1 , … , {N}_{inter} - 1 ,$$
$$where {N}_{inter} is the length of the intermediate frame , or$$
$${x}_{inter , rev} ( m , n ) = \{ \begin{matrix}- {x}_{inter , rev} ( m , n ) , n is odd \\ {x}_{inter , rev} ( m , n ) , n is even\end{matrix} , n = 0 , 1 , … , {N}_{inter} - 1 ,$$
where Nᵢₙₜₑᵣ is the length of the intermediate frame.

10. (canceled)

11. The method of claim 1, further comprising selecting a cut-off frequency of the low pass filtering to be substantially near a middle of the spectrum.

12. The method of claim 11, wherein performing the low pass filtering and decimation of the reversed spectrum to produce the BWE target signal comprises performing the low pass filtering and decimation to align the BWE target signal in a lower half of the spectrum.

13. (canceled)

14. The method of claim 1, further comprising inputting the BWE target signal to a BWE encoder via a BWE target buffer, where the BWE encoder and BWE target buffer are part of an encoder operating on at least two frequency bands.

15. The method of claim 14 wherein the BWE encoder and the BWE target buffer are part of a down-mix encoder of the encoder.

16. The method of claim 15, wherein the down-mix encoder of the encoder comprises at least two encoding modes, wherein at least one of the at least two encoding modes has the BWE encoder.

17. The method of claim 16, wherein the encoder operates on a down-mix signal in a parametric stereo encoder.

18. (canceled)

19. An encoder comprising:
processing circuitry;
memory coupled with the processing circuitry, wherein the memory includes instructions that when executed by the processing circuitry causes the encoder to perform operations comprising:
receive a full band input frame;
interpolate the full band input frame to an intermediate frame;
perform a reversal of a spectrum of the intermediate frame to produce a spectrally reversed intermediate frame;
interpolate the spectrally reversed intermediate frame to match a sampling frequency of a low pass filter and decimation process; and
perform a low pass filtering and decimation of the interpolated spectrally reversed intermediate frame to produce a band width extension, BWE, target signal.

20. The encoder of claim 19, wherein the memory includes instructions that when executed by the processing circuitry causes the encoder to perform operations further comprising:
determine an intermediate length of the intermediate frame Nᵢₙₜₑᵣ.

21. The encoder of claim 20, wherein determine the intermediate length comprises rescaling a length of an input frame N in an input sampling frequency fᵢₙₚᵤₜ until an upper limit of a target band matches a Nyquist frequency in the intermediate frame.

22. The encoder of claim 20, wherein determine the intermediate length comprises determine the intermediate length in accordance with
$${N}_{inter} = N \frac{{f}_{inter}}{{f}_{input}}$$
where
$${f}_{inter} = 2 {f}_{hi}$$
when a target band has limits (fₗₒ, fₕᵢ), Nᵢₙₜₑᵣ is the intermediate length, N is a length of an input frame, and fᵢₙₚᵤₜ is the intermediate sampling frequency.

23. The encoder of claim 19, wherein interpolate the full band input frame comprises using a linear interpolation in interpolating the full band input frame, and wherein using the linear interpolation in interpolating the full band input frame comprises using the linear interpolation to stretch or compress a frame of length N₁ to a frame of length N₂ in accordance with
$${x}_{int} ( i ) = \{ \begin{matrix}\begin{matrix}x ( 0 ) + {i}_{frac} ( x ( 1 ) - x ( 0 ) ) , {i}_{frac} < 0 \\ x ( {N}_{1} - 1 ) + ( {i}_{frac} - {i}_{floor} ) ( x ( {N}_{1} - 1 ) - x ( {N}_{1} - 2 ) ) , {i}_{frac} > {N}_{1} - 1\end{matrix} \\ x ( {i}_{foor} ) + ( {i}_{frac} - {i}_{floor} ) ( x ( {i}_{floor} + 1 ) - x ( {i}_{floor} ) ) , otherwise\end{matrix}$$
$$for i = 0 , 1 , … , {N}_{2} , where$$
$$\{ \begin{matrix}{i}_{floor} = ⌊ {i}_{frac} ⌋ \\ {i}_{frac} = i \frac{{N}_{1}}{{N}_{2}} + {i}_{offset} \\ {i}_{offset} = 0.5 \frac{{N}_{1}}{{N}_{2}} - 0.5 + ϵ\end{matrix}$$
wherein xᵢₙₜ(i) is an interpolated sampling value at point i, x(0) is a sampling point in the source vector x at a first point 0, x(1) is a sampling point in the source vector x at a second point 1, i_{frac} is a fractional point where the source vector x is to be estimated, i_{offset} is an offset, and e is a displacement.

24. (canceled)

25. The encoder of claim 24, wherein ∈ is defined in accordance with
$$ϵ = \{ \begin{matrix}- 0.13 , & \frac{{N}_{1}}{{N}_{2}} > 0.3 \\ 0 , & otherwise\end{matrix}$$

26. The encoder of claim 19, wherein receive the full band input frame comprises receive a full band down-mix signal generated by a discrete Fourier transform, DFT, synthesis.

27. The encoder of claim 19, wherein perform the reversal of the spectrum of the intermediate frame comprises performing the reversal of the spectrum in accordance with:
$${x}_{inter , rev} ( m , n ) = \{ \begin{matrix}- {x}_{inter , rev} ( m , n ) , n is even \\ {x}_{inter , rev} ( m , n ) , n is odd\end{matrix} , n = 0 , 1 , … , {N}_{inter} - 1 ,$$
where Nᵢₙₜₑᵣ is the length of the intermediate frame, or
$${x}_{inter , rev} ( m , n ) = \{ \begin{matrix}- {x}_{inter , rev} ( m , n ) , n is odd \\ {x}_{inter , rev} ( m , n ) , n is even\end{matrix} , n = 0 , 1 , … , {N}_{inter} - 1 ,$$
where Nᵢₙₜₑᵣ is the length of the intermediate frame.

28. (canceled)

29. The encoder method of claim 19, wherein the memory includes instructions that when executed by the processing circuitry causes the encoder to perform operations further comprising:
select a cut-off frequency of the low pass filtering to be substantially near a middle of the spectrum.

30. The encoder of claim 29, wherein performing the low pass filtering and decimation of the reversed spectrum to produce the BWE target signal comprises to perform the low pass filtering and decimation to align the BWE target signal in a lower half of the spectrum.

31. The encoder of claim 30, wherein a decimator frame length is determined in accordance with
$${N}_{dec} = {N}_{inter} \frac{{f}_{dec}}{{f}_{inter}}$$
where N_{dec} is the decimator frame length, Nᵢₙₜₑᵣ is an intermediate length, f_{dec} is a frequency of operation of a decimator, and fᵢₙₜₑᵣ is a frequency of the intermediate frame.

32. The encoder of claim 19, wherein the memory includes instructions that when executed by the processing circuitry causes the encoder to perform operations further comprising:
input the BWE target signal to a BWE encoder via a BWE target buffer, where the BWE encoder and BWE target buffer are part of an encoder operating on at least two frequency bands.

33. The encoder of claim 32, wherein the BWE encoder and the BWE target buffer are part of a down-mix encoder of the encoder.

34. The encoder of claim 33, wherein the down-mix encoder of the encoder comprises at least two encoding modes, wherein at least one of the at least two encoding modes has the BWE encoder.

35. The encoder of claim 34, wherein the encoder operates on a down-mix signal in a parametric stereo encoder.

36. (canceled)

37. (canceled)
